(19) United States
(12) Patent Application Publication
(10) Pub. No.: US 2026/0367935 A1
(43) Pub. Date: Nov. 19, 2026

(54) Applying a Machine Learning Model to Form Metadata for Generation of Requirements, Display Information, and/or Interface Elements for a Data Collection Interface

(71) Applicant: Oracle International Corporation, Redwood Shores, CA (US)

(72) Inventors: Allen Roshan D’Souza, Houston, TX (US); Venkata Narsimha Rao Gurrapu Srinivas, Hyderabad (IN); Veera Venkata Naga Raju Sripada, Cupertino, CA (US); Hephzibah Peruri, Hyderabad (IN); Bharat Suram, Hyderabad (IN); Robert Anthony Johnson, Melbourne, FL (US); Ankur Handa, Santa Clara, CA (US); Dipen Ashvinkumar Joshi, Katy, TX (US)

(73) Assignee: Oracle International Corporation, Redwood Shores, CA (US)

(21) Appl. No.: 19/212,438

(22) Filed: May 19, 2025

(51) Int. Cl. G06F 9/451; G06F 40/174

(52) U.S. Cl. CPC G06F 9/451; G06F 40/174

(57) ABSTRACT

The system obtains training data for machine learning model training to generate interface element attributes within data collection interfaces. The system processes training datasets comprising form field characteristics associated with fields in forms. The system associates interface element attributes with interface elements corresponding to fields in forms. The system receives form metadata for target forms. The system applies machine learning models to form metadata to generate target interface element attribute sets corresponding to target interface element sets. The system generates data collection interfaces comprising target interface elements with target interface element attributes to collect user input corresponding to target forms.

### TECHNICAL FIELD

The present disclosure relates generally to electronic forms processing and data collection interfaces, and more particularly to systems and methods for processing of data related to forms.

### BACKGROUND

Organizations across various industries routinely manage numerous forms for regulatory compliance, business operations, and customer interactions. These forms include tax withholding documents, human resources paperwork, financial applications, and various government-mandated filings. Form publishers, including government agencies and regulatory bodies, design forms with specific field characteristics, space allocations, instructions, and validation requirements. When organizations create data collection interfaces based on these forms, they interpret these characteristics to determine appropriate interface element attributes, such as field names, instructions, character limits, and validation rules. This interpretation process is traditionally manual, time-consuming, and susceptible to inconsistencies.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates a data collection interface generation system in accordance with one or more embodiments;

FIG. 2 illustrates an example set of operations for generating a data collection interface in accordance with one or more embodiments;

FIG. 3 illustrates an exemplary generation of a data collection interface in accordance with one or more embodiments;

FIG. 4 shows a block diagram of a machine learning engine in accordance with one or more embodiments;

FIG. 5 illustrates the operation of a machine learning engine in accordance with one or more embodiments; and

FIG. 6 shows a block diagram that illustrates a system in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.
1. GENERAL OVERVIEW
2. DATA COLLECTION INTERFACE GENERATION ARCHITECTURE
3. METHOD OF GENERATING DATA COLLECTION INTERFACE
4. DATA COLLECTION INTERFACE GENERATION EXAMPLE
5. PRACTICAL APPLICATIONS, ADVANTAGES & IMPROVEMENTS
6. MISCELLANEOUS; EXTENSIONS
7. MACHINE LEARNING ARCHITECTURE
8. HARDWARE OVERVIEW

### 1. General Overview

One or more embodiments apply a machine learning model to form metadata to generate attributes of interface elements for a data collection interface that gathers user input corresponding to a form. The system trains the machine learning model using training data sets that include form metadata for a historical form and attributes of interface elements for a data collection interface that gathers input corresponding to the historical form. The form metadata may include any characteristics of the historical form such as, for example, an amount of space within the historical form to enter input for a form field. The attribute of the interface element, configured to collect the input for the form field, may include a character limit of a displayed text input box presented by a data collection interface. Based on the training data set described in this example, the machine learning model learns how to select a character limit for the displayed text input box based on the amount of space within the historical form. Once trained, the machine learning model is used to intake new or updated forms. The machine learning model is applied to the metadata corresponding to the new or updated forms to generate attributes of interface elements for a data collection interface that gathers user input corresponding to the new or updated forms.

One or more embodiments apply a machine learning model to form metadata to generate requirements or display information, such as instructions, for a data collection interface that gathers user input corresponding to a form. The system trains the machine learning model using training data sets that include form metadata for a historical form and requirements or display information for a data collection interface that gathers input corresponding to the historical form. In an example, a training data set may include (a) an original instruction within the historical form for completing a field of the historical form and (b) a displayed instruction presented by a data collection interface for obtaining user input for the field of the historical form. The machine learning model learns how to translate the original instruction to the displayed instruction. The translation may include shortening a well-understood instruction or adding more detail to a confusing instruction. In other example, the training data set may include an original field name for a field within the historical form and a displayed field name presented by the data collection interface for obtaining user input for the field in the historical form. Once trained, the machine learning model is used to intake new or updated forms. The machine learning model is applied to the metadata corresponding to the new or updated forms to generate requirements or display information for the data collection interface that gathers user input corresponding to the new or updated forms.

One or more embodiments described in this Specification and/or recited in the claims may not be included in this General Overview section.

### 2. Data Collection Interface Generation Architecture

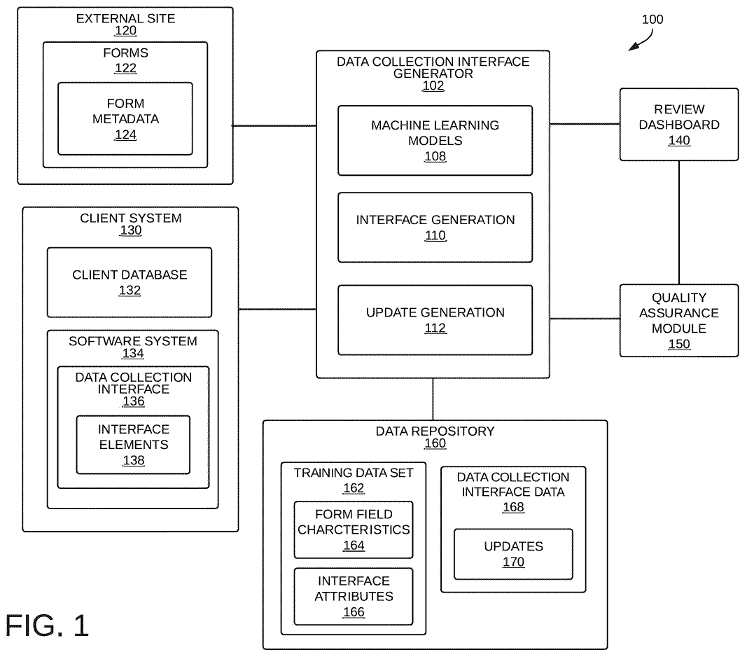

FIG. 1 illustrates a system 100 in accordance with one or more embodiments. As illustrated in FIG. 1, system 100 includes data collection interface generator 102, machine learning models 108, interface generation 110, update generation 112, review dashboard 140, quality assurance module 150, data repository 160, training dataset 162, form field characteristics 164, interface attributes 166, data collection interface data 168, updates 170, external site 120, forms 122, form metadata 124, client system 130, client database 132, software system 134, data collection interface 136, and interface elements 138.

In an embodiment, data collection interface generator 102 transforms form metadata into interface element attributes and generates data collection interfaces through application of machine learning techniques. Data collection interface generator 102 receives form metadata 124 from external sources, extracts relevant characteristics, and processes these characteristics through trained machine learning models to determine appropriate interface implementations. Data collection interface generator 102 coordinates interactions between multiple system components, including machine learning models 108, interface generation 110, and update generation 112, to ensure consistent application of learned patterns across newly generated interfaces. Data collection interface generator 102 communicates with external site 120 to acquire forms acquisition and with client system 130 for interface deployment.

In an embodiment, machine learning models 108 transform form field characteristics into corresponding interface element attributes through application of pattern recognition techniques. Machine learning models 108 accept input features derived from form field characteristics, such as field names, instructions, space allocations, and field types extracted from original forms. Machine learning models 108 produce output predictions for interface element attributes, including displayed field names, interface instructions, character limits, and validation rules based on learned patterns from historical form-interface pairs. In one example, machine learning models 108 employ supervised learning methods trained on labeled examples where effective interface implementations for specific form fields have been previously determined and validated. Machine learning models 108 utilize computational techniques, such as neural networks, decision trees, random forests, or gradient boosting methods, depending on attribute prediction requirements.

In an embodiment, machine learning models 108 incorporate multiple specialized sub-models that address distinct aspects of interface attribute generation. Machine learning models 108 include field name translation models that focus specifically on converting formal or technical field names from original forms into user-friendly displayed names suitable for interface presentation. Machine learning models 108 implement instruction transformation models trained to simplify verbose instructions or expand incomplete guidance based on field context and complexity. Machine learning models 108 utilize character limit prediction models that correlate physical space allocations in original forms with appropriate digital constraints for corresponding interface elements. Machine learning models 108 feature ensemble techniques that combine predictions from multiple method types to improve accuracy across diverse form types and attribute categories.

In an embodiment, interface generation 110 converts machine learning model predictions into concrete interface specifications ready for implementation in client systems. Interface generation 110 processes raw prediction outputs from machine learning models 108, applying formatting rules, consistency checks, and integration logic to create comprehensive interface element attribute sets. Interface generation 110 organizes generated attributes according to form structure, preserving section relationships, field groupings, and logical dependencies present in original forms. Interface generation 110 generates deployment packages that include interface specifications, combining machine learning-generated attributes with technical implementation requirements, such as rendering instructions, event handling procedures, and data binding configurations. Interface generation 110 maintains version control for generated interfaces, tracking attribute lineage back to source form versions and model iterations used during generation.

In an embodiment, update generation 112 produces modification specifications for existing data collection interfaces when form changes occur and prepares these updates for delivery to client system 130. Update generation 112 identifies differences between previous form versions and updated forms, isolating field additions, removals, and modifications requiring interface attribute recalculation. Update generation 112 creates differential update packages that include modified interface components and deploys these packages to client systems through standardized delivery mechanisms, minimizing implementation disruption while ensuring client interfaces remain synchronized with the latest form requirements.

In an embodiment, external site 120 is a source repository that provides forms issued by regulatory bodies, government agencies, or standard-setting organizations. External site 120 publishes forms through structured portals, searchable directories, or programmatic interfaces accessible to data collection interface generator 102. External site 120 employs various document formats, including Portable Document Format (PDF), Hypertext Markup Language (HTML), image-based documents, or structured data representations that require appropriate extraction techniques for accessing form content.

In an embodiment, forms 122 constitute document specifications that define structured data collection requirements for regulatory compliance, business operations, or information gathering purposes. Forms 122 include defined fields, sections, and instructions that establish data collection parameters for specific administrative, financial, or legal processes. Forms 122 specify validation constraints, including required fields, format restrictions, numerical ranges, or relationship rules governing acceptable input values.

In an embodiment, form metadata 124 comprises representations of form characteristics that serve as input features for machine learning methods predicting interface element attributes. Form metadata 124 includes field names extracted from form labels, section headings, or reference identifiers specifying data collection targets within original forms. Form metadata 124 includes instruction text associated with individual fields, sections, or overall form completion, providing guidance context for interface instruction generation. Form metadata 124 quantifies spatial characteristics, such as field length, width, positioning, and relative size within original forms, enabling correlation with appropriate digital constraints for interface elements. Form metadata 124 encodes field types, answer formats, or validation patterns extracted from explicit instructions or implicit form design signals.

In an embodiment, client system 130 operates as a deployment environment that executes software applications incorporating generated data collection interfaces for end-user interaction. Client system 130 receives interface specifications from data collection interface generator 102, implementing interface elements with attributes determined through machine learning processes. Client system 130 renders visual representations of interface elements according to generated specifications, creating functional data collection operation aligned with original form requirements. Client system 130 processes user inputs against validation rules derived from machine learning predictions, enforcing data quality constraints appropriate to field types and requirements. Client system 130 stores collected data according to schemas reflecting form structures, maintaining correspondence between digital records and original form organization.

In an embodiment, client database 132 provides persistent storage facilities for data captured through form-based collection interfaces. Client database 132 implements relational or document-oriented storage structures that correspond to form organizations, maintaining field relationships defined in original forms.

In an embodiment, software system 134 executes application logic that controls form-based workflows, data collection processes, and user interactions with generated interfaces. Software system 134 renders data collection interface 136 according to specifications received from data collection interface generator 102, creating visual representations of interface elements with attributes determined through machine learning processes.

In an embodiment, data collection interface 136 presents interactive digital environments for users to provide information corresponding to underlying form requirements. Data collection interface 136 displays visual representations of form fields, instructions, and structural organization translated from physical or PDF forms into web-based or application-based interactive elements. Data collection interface 136 organizes input components according to logical groupings derived from original form structures, preserving section relationships and completion flow.

In an embodiment, interface elements 138 function as interactive components within data collection interface 136, corresponding to a specific data collection field from original forms. Interface elements 138 display labels, instructions, and input areas with attributes determined by machine learning models 108 based on analysis of corresponding fields in original forms. Interface elements 138 implement appropriate input mechanics based on field type classification, presenting text boxes, drop-down selections, radio buttons, checkboxes, date pickers, or specialized input formats matching data collection requirements. Interface elements 138 enforce validation constraints that prevent invalid entries, ensuring collected data meets format requirements, value ranges, or relationship rules defined in original forms. Interface elements 138 provide visual feedback, indicating validation status, completion requirements, or dependency relationships with other form elements.

In an embodiment, interface elements 138 incorporate multiple attributes directly influenced by machine learning predictions based on form field analysis. Interface elements 138 display field labels generated through machine learning translation of original form terminology into user-friendly language while preserving essential meaning. Interface elements 138 present instruction text derived through machine learning transformation of original guidance, improving clarity and length for digital presentation contexts. Interface elements 138 implement character limits or input masks determined through machine learning correlation between physical space allocations in original forms and appropriate digital constraints. Interface elements 138 adjust visual prominence through size, positioning, or styling based on machine learning assessment of field importance derived from original form design signals. The interface element 138 includes a input region for the input field that solicits user input.

In an embodiment, review dashboard 140 serves as an oversight mechanism for evaluating and approving changes generated through machine learning processes. Review dashboard 140 facilitates approval workflows that collect necessary authorizations before changes deploy to client systems 130. Review dashboard 140 maintains approval history, documenting review decisions, approvers, and timestamps throughout change management processes.

In an embodiment, quality assurance module 150 executes testing procedures that verify correct implementation of form updates before production deployment. Quality assurance module 150 executes test scenarios against staging implementations of updated forms. Quality assurance module 150 validates that field operations, such as field additions, removals, and modifications, function correctly within integrated environments. Quality assurance module 150 verifies calculation accuracy, conditional logic operation, and validation rule enforcement, matching specifications from updated forms.

In one or more embodiments, data repository 160 is any type of storage unit and/or device, such as a file system, database, collection of tables, or any other storage mechanism, for storing data. Furthermore, data repository 160 may include multiple different storage units and/or devices. The multiple different storage units and/or devices may or may not be of the same type or located at the same physical site. Furthermore, data repository 160 may be implemented or executed on the same computing system as data collection interface generator 102. Additionally, or alternatively, data repository 160 may be implemented or executed on a computing system separate from data collection interface generator 102. Data repository 160 may be communicatively coupled to data collection interface generator 102 via a direct connection or via a network.

In an embodiment, training dataset 162 includes structured examples pairing form field characteristics with corresponding interface element attributes, providing knowledge for machine learning model training. Training dataset 162 includes representation of diverse form types, field categories, and interface implementation. Training dataset 162 maintains both original form field characteristics, such as names, instructions, and space allocations, alongside successfully implemented interface attributes, including displayed names, interface instructions, and character limits for corresponding elements. In one example, training dataset 162 incorporates quality indicators for example pairs, identifying particularly successful implementations that deserve higher weighting during training processes. Training dataset 162 is increased as newly processed forms receive successful interface implementations, expanding knowledge representation for subsequent model improvements.

In an embodiment, interface attributes 166 maintain records of successfully implemented interface element characteristics corresponding to specific form fields, providing target outputs for machine learning training processes. Interface attributes 166 include displayed field names that represent user-friendly translations of original form terminology while preserving essential meaning and identification purposes. Interface attributes 166 store interface instructions that provide guidance text for digital presentation contexts through appropriate length, clarity, and formatting for screen-based viewing. Interface attributes 166 preserve numerical parameters, such as character limits, minimum/maximum values, or size specifications, that define input constraints and visual presentation characteristics for interface elements. Interface attributes 166 capture validation rule definitions specifying acceptable input patterns, required formats, or value relationships enforced during data collection.

In an embodiment, data collection interface data 168 stores specifications for implemented interfaces, combining machine learning-generated attributes with technical implementation details required for deployment. Data collection interface data 168 maintains interface definitions, including elements, attributes, behaviors, and relationships, comprising functional data collection experiences aligned with original form requirements. Data collection interface data 168 preserves logical structure representations that document section organizations, field groupings, and completion pathways derived from original form designs. Data collection interface data 168 stores various technical implementation details, including rendering instructions, event handling procedures, and data binding configurations required for execution in client environments. Data collection interface data 168 maintains version identifiers that establish clear correspondence between interface implementations and underlying form versions, ensuring regulatory compliance through accurate version alignment.

In an embodiment, updates 170 document changes implemented in response to form modifications detected by system 100. Updates 170 record detailed change specifications, including field additions, removals, validation adjustments, and instruction modifications. Updates 170 preserve approval records that link changes to authorization events recorded through review dashboard 140. Updates 170 support audit processes, demonstrating timely implementation of regulatory form changes when required for compliance purposes.

In one or more embodiments, data collection interface generator 102, machine learning models 108, interface generation 110, update generation 112, client database 132, software system 134, data collection interface 136, interface elements 138, review dashboard 140, and quality assurance module 150 refer to hardware and/or software configured to perform operations described herein for interface element attribute generation.

In an embodiment, data collection interface generator 102, machine learning models 108, interface generation 110, update generation 112, client database 132, software system 134, data collection interface 136, interface elements 138, review dashboard 140, and quality assurance module 150 are implemented and/or stored on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware network address translator (NAT), a hardware load balancer, a mainframe, a television, a content receiver, a set-top box, a printer, a mobile handset, a smartphone, a personal digital assistant (PDA), a wireless receiver and/or transmitter, a base station, a communication management device, a router, a switch, a controller, an access point, and/or a client device.

### 3. Method of Generating Data Collection Interface

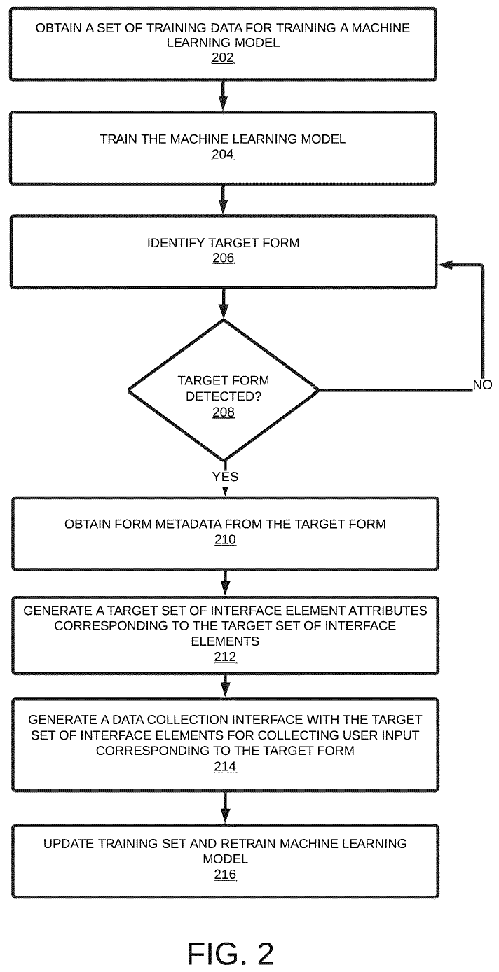

FIG. 2 illustrates an example set of operations for generating interface element attributes using machine learning in accordance with one or more embodiments. One or more operations illustrated in FIG. 2 may be modified, rearranged, or omitted. Accordingly, the particular sequence of operations illustrated in FIG. 2 should not be construed as limiting the scope of one or more embodiments.

### Machine Learning System for Interface Generation

In an embodiment, the system obtains a set of training data for training a machine learning model to generate interface element attributes for interface elements within a data collection interface (Operation 202). The machine learning model uses training data to learn how to effectively transform form characteristics into interface elements. The system executes data extraction routines that target repositories of historical form implementations, retrieving paired examples of original form fields and corresponding interface elements. Through form analysis, the system parses forms to extract field characteristics, including field names, instructions, space allocations, and validation requirements, from original forms. During implementation review, the system captures interface implementation details through code analysis and rendering inspection, documenting displayed names, interface instructions, character limits, and validation rules used in deployed interfaces. The system organizes extracted information into structured training samples that link input features from form fields with output targets from interface implementations, creating paired examples suitable for supervised learning approaches.

In an embodiment, the system formats extracted training data according to requirements of selected machine learning methods. The system normalizes textual content through tokenization, stemming, and case standardization, creating consistent representations of field names and instructions across diverse forms. Spatial measurements from various units are converted into standardized values, enabling consistent interpretation of space allocations despite differing form layouts and dimensions. Categorical attributes, such as field types, are transformed into numerical encodings through one-hot vectors or embedded representations suitable for mathematical processing. Data validation procedures are implemented, verifying completeness, consistency, and accuracy of training pairs before inclusion in training datasets.

In an embodiment, the system applies data augmentation techniques that expand training datasets with additional examples derived from original form-interface pairs. The system generates synthetic variations through controlled modifications of field names, instructions, and space allocations while preserving essential meaning and purpose. Domain-specific transformations are implemented, replicating common variations encountered in form terminology, such as abbreviation expansion, synonym substitution, or formatting alterations. In a validation processes, the system validates augmented examples through consistency checks, ensuring generated variations remain plausible and meaningful within domain contexts.

In an embodiment, the system trains the machine learning model using the training data (Operation 204). The training phase enables the model to learn patterns and relationships between form field characteristics and corresponding interface implementations. The system selects appropriate method types based on prediction tasks, such as by employing neural networks for text transformations, decision trees for classification decisions, or regression models for numerical attribute prediction. Model architectures are configured, specifying layer structures, connection patterns, and activation functions for neural approaches, or alternatively, tree depths, splitting criteria, and ensemble methods for decision tree approaches. Training protocols are established, defining batch sizes, learning rates, optimization methods, and convergence criteria that control training progression. Regularization techniques are implemented, including dropout, weight decay, or early stopping, preventing overfitting to training examples while preserving generalization capabilities.

In an embodiment, the machine learning model is specifically trained to generate interface element attributes by analyzing multiple types of correlations in the training data. Correlations between original field names in historical forms and corresponding displayed field names in previously produced data collection interfaces are analyzed, learning how to translate technical or formal terminology into user-friendly labels while preserving essential meaning. Correlations between original instructions in the historical forms and corresponding displayed instructions in the previously produced interfaces are also analyzed, identifying patterns for simplifying complex guidance or expanding insufficient explanations based on field context. Correlations between space allocations in the historical forms and corresponding character limits in the previously produced interfaces are analyzed, determining appropriate digital constraints based on physical dimensions and expected input length. These correlation analyses enable the model to translate a wide variety of form field characteristics into interface attributes based on successful historical implementations.

In an embodiment, the system executes multi-stage training processes that address different aspects of interface attribute generation. The system implements transfer learning approaches leveraging pre-trained language models for text understanding tasks, fine-tuning these foundations for domain-specific interpretation of form terminology and instructions. Through structural encoding, the system develops specialized feature extractors that convert spatial attributes, field relationships, and structural patterns into numerical representations capturing layout significance. Curriculum learning strategies are employed that present increasingly difficult transformation examples as training progresses, starting with straightforward field name translations before advancing to instruction transformations. Separate validation datasets are maintained that measure generalization performance throughout training, preventing decisions based solely on training set performance.

In an embodiment, the system identifies a target form requiring a data collection interface (Operation 206). The system monitors form repositories through scheduled scanning operations, detecting new publications or version updates from regulatory authorities, government agencies, or standardization bodies. The system executes similarity analysis that compares detected forms against known form inventories, distinguishing between previously processed forms and new additions requiring interface generation. The system applies document classification techniques that categorize detected forms by industry domain, regulatory purpose, or organizational function, enabling specialized processing workflows appropriate to form categories. During identification, the system extracts identification markers that include form codes, version numbers, effective dates, or official titles, establishing unique identities for processing tracking.

In an embodiment, the system determines if a target form is detected (Operation 208). The system evaluates results from form monitoring and identification processes, checking if new forms requiring interface generation exist in processing queues. If a target form is detected, the system proceeds to operation 210, advancing to metadata extraction processes supporting interface attribute generation. If no target form is detected, the system returns to operation 206, continuing monitoring activities through scheduled scanning cycles.

In an embodiment, the system obtains form metadata from the target form (Operation 210). Extracting metadata provides the input features for the machine learning model to process. The system executes extraction routines capturing detailed information about form fields, sections, instructions, and structural relationships within detected target forms. Optical character recognition is applied for image-based documents or direct parsing for digital formats, extracting textual content including field labels, section headings, and instruction blocks. Spatial analysis is performed to measure field dimensions, positioning coordinates, and relative sizing within layout contexts, quantifying physical characteristics influencing interface representations. Field type indicators are identified through label text, formatting patterns, or explicit type designations, categorizing input requirements for fields across the form document.

In an embodiment, the system extracts form metadata from the target form through parsing techniques. This metadata includes field names that identify data collection points, instructions that guide form completion, space allocations indicating physical dimensions for input areas, field types determining appropriate interface controls, and form structure information preserving hierarchical relationships and logical groupings from the original design. The extraction process combines optical character recognition, spatial analysis, and/or pattern recognition to create a complete representation of the form's characteristics for processing by the machine learning model.

In an embodiment, the system executes specialized extraction procedures targeting specific metadata categories essential for interface attribute generation. The system identifies instruction text through proximity analysis, typographical patterns, or explicit labeling, associating guidance content with corresponding fields or sections. Example values, format patterns, and placeholder text are extracted, demonstrating expected input formats and value constraints for form fields. Section groupings are analyzed, detecting hierarchical structures, logical groupings, and sequential relationships between form components. Conditional logic expressions are identified where certain fields become relevant based on responses to previous questions, capturing decision pathways embedded in form designs.

In an embodiment, the system normalizes extracted metadata to create standardized representations suitable for machine learning model inputs. The system applies text normalization that converts varied capitalizations, spellings, and abbreviations into consistent formats while preserving meaning and identification purpose. The system standardizes spatial measurements that transform physical dimensions from document-specific units into normalized values, supporting consistent interpretation across different form types. The system converts detected field types into categorical encodings recognized by machine learning models, mapping diverse type indicators into standardized classification schemes. The system resolves reference chains where instructions refer to other form sections or external documents, creating self-contained metadata representations for processing operations.

In an embodiment, the system applies the machine learning model to the form metadata to generate a target set of interface element attributes corresponding to a target set of interface elements (Operation 212). At this point, the trained model transforms form metadata into specific interface attributes that will be used to create the data collection interface. The system prepares extracted metadata as input features, formatting field names, instructions, space allocations, and type information according to model input requirements. The system executes prediction operations that apply trained machine learning models to input features, generating predicted interface element attributes for fields identified in target forms. The system combines predictions across multiple specialized models, integrating field name translations, instruction transformations, character limit determinations, and validation rule generations into coherent attribute sets. The system applies post-processing operations that format prediction outputs according to implementation requirements, converting raw model outputs into structured attribute specifications suitable for interface generation.

In an embodiment, the system applies specialized processing for different field types, addressing unique requirements of various input categories. The system tailors attribute generation for text input fields, determining appropriate character limits, input masks, and validation patterns based on content expectations and space allocations. The system generates specialized attributes for selection fields including option lists, selection mechanisms, and defaulting behaviors based on instruction analysis and field context. The system develops date field configurations that specify format requirements, range restrictions, and picker implementations based on date context and precision requirements. The system creates numeric field attributes that define acceptable ranges, decimal precision, and formatting patterns based on numerical context and expected values.

In an embodiment, the interface element attributes generated by the machine learning model include specific display characteristics tailored to different types of form fields. The system applies specialized attribute generation for various field categories, including text input fields, numeric input fields, selection fields, such as dropdowns, radio buttons, and checkboxes, date fields with calendar controls, and signature fields requiring specialized capture mechanisms. Field types receive treatment based on its unique requirements, with historical patterns, the machine learning model applying patterns learned from successful historical implementations of similar field types across previous forms.

In an embodiment, the system performs context-aware translation of field names from original forms to displayed names for interface elements. The system analyzes original field names, identifying technical terminology, domain-specific jargon, or formal phrasing requiring simplification for general user comprehension. The system applies learned transformation patterns, converting lengthy or complex labels into concise versions suitable for interface presentation while preserving essential meaning. The system maintains terminology consistency across related field groups, ensuring conceptual relationships remain clear despite label translations. The system preserves critical identifiers or reference codes within translated names when required for cross-referencing or compliance purposes, integrating these elements into user-friendly presentations.

In an embodiment, the system determines character limits and size constraints for input fields based on space allocations and content expectations. The system analyzes space provided in original forms, measuring input regions and correlating dimensions with typical content requirements for corresponding fields. The system applies learned patterns from historical implementations, determining appropriate character limits based on field purpose, expected input length, and usability considerations. The system establishes minimum size thresholds that ensure fields remain usable regardless of content brevity, preventing unusably small input areas for fields with variable content expectations. The system calculates appropriate expansion behavior for multiline inputs, determining initial presentation dimensions and growth constraints based on content type and form context.

In an embodiment, the system generates validation rules that enforce data quality and format requirements implied by form designs. The system identifies explicit validation requirements from instructional content, example formats, or field labels, specifying acceptable inputs. The system infers implicit validation requirements from field contexts, space allocations, or relationship patterns, suggesting value constraints or format expectations. The system creates format validation rules that specify character patterns, separator requirements, or structural constraints, ensuring inputs match expected formats for specific field types. The system develops relationship validations that enforce logical connections between fields where values in one field affect acceptable inputs in related fields.

In an embodiment, the system specifically translates original instructions within the target form to displayed instructions presented by the data collection interface. This translation process involves either shortening verbose instructions that are well-understood or adding clarifying details to confusing instructions based on patterns the machine learning model has learned from historical form-interface pairs. The system analyzes the complexity, context, and purpose of instructions to determine whether simplification or elaboration would improve user understanding while maintaining compliance with the form's requirements.

In an embodiment, the system generates a data collection interface comprising the target set of interface elements, with the target set of interface element attributes, for collecting user input corresponding to the target form (Operation 214). The system now creates the actual interface that end users will interact with, implementing the attributes determined by the machine learning model. The system creates implementation specifications that translate generated attributes into technical definitions for rendering interface elements within target environments. The system builds structural frameworks that organize interface elements according to section relationships, logical groupings, and completion sequences derived from original form structures. The system implements navigation patterns that define movement paths between fields, section transitions, and completion flows, supporting effective user progression through interface content.

In an embodiment, the system develops presentation specifications that control visual aspects of interface elements based on generated attributes and implementation requirements. The system determines appropriate input mechanism types, selecting text boxes, drop-down selections, radio buttons, checkboxes, date pickers, or specialized inputs based on field types and interaction requirements. The system establishes sizing parameters defining width, height, and expansion characteristics for input elements based on generated character limits, expected content volume, and display context constraints. The system creates label presentations that position field names, organizing instruction text, and arranging help content according to readability principles and space efficiency requirements. The system implements validation feedback mechanisms that display error messages, format guidance, and correction suggestions derived from generated validation rules.

In an embodiment, the system applies responsive design principles that ensure interfaces function effectively across diverse device types and screen dimensions. The system develops layout adaptation rules that define repositioning, resizing, and reformatting behaviors when interfaces render across different screen sizes and orientations. The system implements progressive disclosure strategies for instruction content, determining when guidance appears automatically versus remaining available through user-triggered expansions based on field complexity and screen constraints. The system establishes touch accommodation features that ensure interactive elements maintain sufficient size and spacing for effective touch interaction while preserving space efficiency on larger screens.

In an embodiment, the system establishes interaction behavior specifications that define dynamic aspects of interface operation during user engagement. The system implements real-time validation procedures that provide immediate feedback when user inputs violate format requirements, value constraints, or relationship rules defined by generated validation attributes. The system develops conditional display logic that controls visibility of fields based on responses to previous questions, implementing dependency relationships identified in form structures. The system creates calculation behaviors automatically generating derived values when fields depend on mathematical operations applied to other inputs. The system establishes focus management rules that determine field activation sequences, tab ordering, and keyboard navigation patterns, supporting efficient completion workflows.

In an embodiment, the system updates the training set and retrains machine learning model (Operation 216). Such a feedback loop allows for continuous improvement as the system learns from new forms as they are processed. The system captures comprehensive records pairing form metadata with generated interface attributes, preserving complete examples for future learning improvements. The system implements version tracking that associates stored examples with specific model versions used during generation, enabling correlation between model iterations and attribute quality. The system establishes quality indicators based on implementation success, reviewer feedback, or performance metrics, differentiating highly successful translations for weighted treatment in subsequent training cycles. The system organizes stored examples within training repositories according to form categories, field types, and attribute patterns, supporting targeted retraining for specific generation aspects.

In an embodiment, the system enhances stored examples with contextual information, supporting improved learning in subsequent training cycles. The system adds domain classification markers that identify regulatory categories, organizational functions, or subject matter areas for form-interface pairs, enabling domain-specific pattern recognition. The system preserves modification histories when generated attributes receive adjustments through review processes, documenting both original predictions and human-refined versions for comparative learning. The system attaches performance metrics from deployed interfaces, such as completion rates, error frequencies, or user feedback scores, providing outcome measures for generated attributes. The system documents special handling cases where standard patterns required adaptation for unusual form characteristics, capturing exception management strategies for future improvements.

In an embodiment, the system periodically retrains the machine learning model using the additional training data to improve accuracy in generating interface element attributes for subsequent form updates. The system establishes retraining schedules based on accumulated example volume, performance indicators, or elapsed time since previous training iterations. The system prepares expanded training datasets that incorporate newly collected examples alongside previous training data, creating comprehensive learning foundations covering evolving patterns. The system adjusts training parameters based on performance analysis, modifying learning rates, regularization strengths, or architectural features addressing identified weakness areas. The system implements transfer learning approaches that preserve knowledge from previous model versions while incorporating new patterns from recent examples, balancing stability and improvement.

In an embodiment, the system applies the retrained machine learning model to subsequent form metadata to generate improved interface element attributes for data collection interfaces. The system implements model versioning controls that ensure current model iterations deploy to production generation workflows after successful retraining and validation. The system performs comparative analysis between previous and retrained models, measuring improvement metrics across attribute categories and form types. The system establishes fallback mechanisms that maintain operational capability through previous model versions if retrained models encounter unexpected performance issues during initial deployment phases. The system monitors prediction performance during operational use, collecting outcome metrics supporting decisions for future retraining cycles.

### 4. Data Collection Interface Generation Example

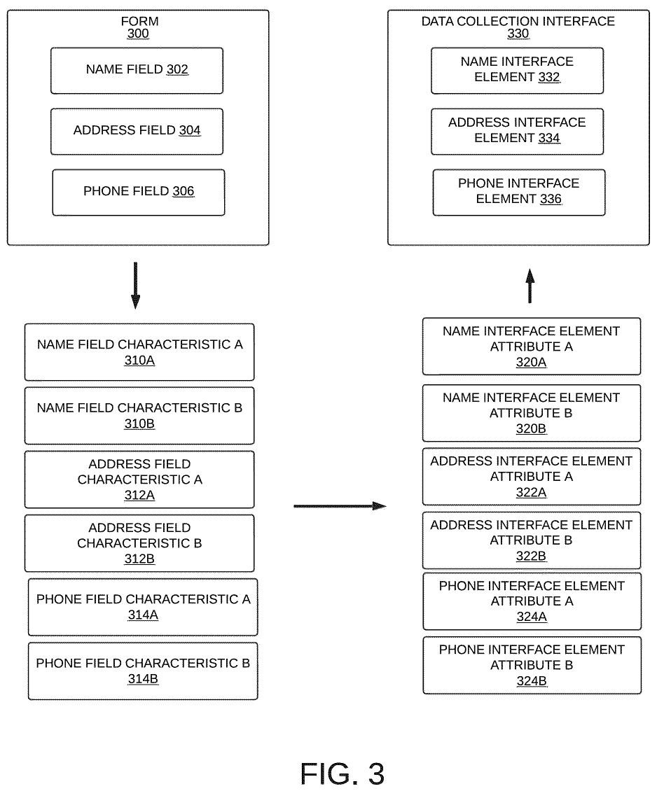

FIG. 3 illustrates an exemplary relationship between form fields and interface elements in accordance with one or more embodiments. FIG. 3 demonstrates how form field characteristics are translated into interface element attributes through the machine learning model.

In an embodiment, form 300 includes several fields: name field 302, address field 304, and phone field 306. Form fields have associated characteristics: name field attributes 310A and 310B for name field 302, address field attributes 312A and 312B for address field 304, and phone field attributes 314A and 314B for phone field 306. These form field characteristics represent characteristics extracted from the original form, such as field names, instructions, space allocations, and validation requirements.

In an embodiment, interface element attributes for data collection interface 330 include name interface element attributes 320A and 320B for name interface element 332, address interface element attributes 322A and 322B for address interface element 334, and phone interface element attributes 324A and 324B for phone interface element 336. These interface element attributes represent characteristics determined by the machine learning model, such as displayed field names, interface instructions, character limits, and validation rules. These interface element attributes are used to construct the data collection interface 330, including corresponding interface elements: name interface element 332, address interface element 334, and phone interface element 336. In an example, the interface elements are input fields that solicit user input.

In an embodiment, the arrow between the form field characteristics and interface element attributes represents the transformation performed by the machine learning model. The model analyzes patterns in historical form-interface pairs to determine the translation of form field characteristics into interface element attributes. This transformation process improves consistency, usability, and data collection quality by applying learned patterns rather than requiring manual interpretation for new form fields. In one example, name field attribute 310A represents the original field name instruction, such as “Full Legal Name (First, Middle, Last)”) from the form, while name interface element attribute 320A is the translated displayed instruction, such as “Full Name”, generated by the machine learning model for the interface. In another example, name field attribute 310B is a size of the input field, such as in centimeters, in the form for name field 302, while name interface element attribute 320B is the translated input field size, such as in maximum characters, for use with name interface element 332 in data collection interface 330.

### 5. Practical Applications, Advantages, & Improvements

The system provides network-level technical improvements to form processing infrastructure by dynamically improving data transmission, storage, and computational resource allocation during interface generation processes. By applying trained models to form metadata, the system reduces network traffic compared to traditional manual template creation methods while simultaneously decreasing computational load on client systems through server-side attribute prediction. The system's continuous self-improvement mechanism further enhances these technical benefits over time by capturing successful implementation patterns and incorporating them into subsequent model iterations, creating a feedback loop that progressively improves network performance metrics without requiring manual reconfiguration or extensive developer intervention.

### 6. Miscellaneous; Extensions

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected and every effort made to prevent their use in any manner which might adversely affect their validity as trademarks.

Embodiments are directed to a system with one or more devices that include a hardware processor and that are configured to perform any of the operations described herein and/or recited in any of the claims below.

In an embodiment, one or more non-transitory computer readable storage media comprises instructions which, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

### 7. Machine Learning Architecture

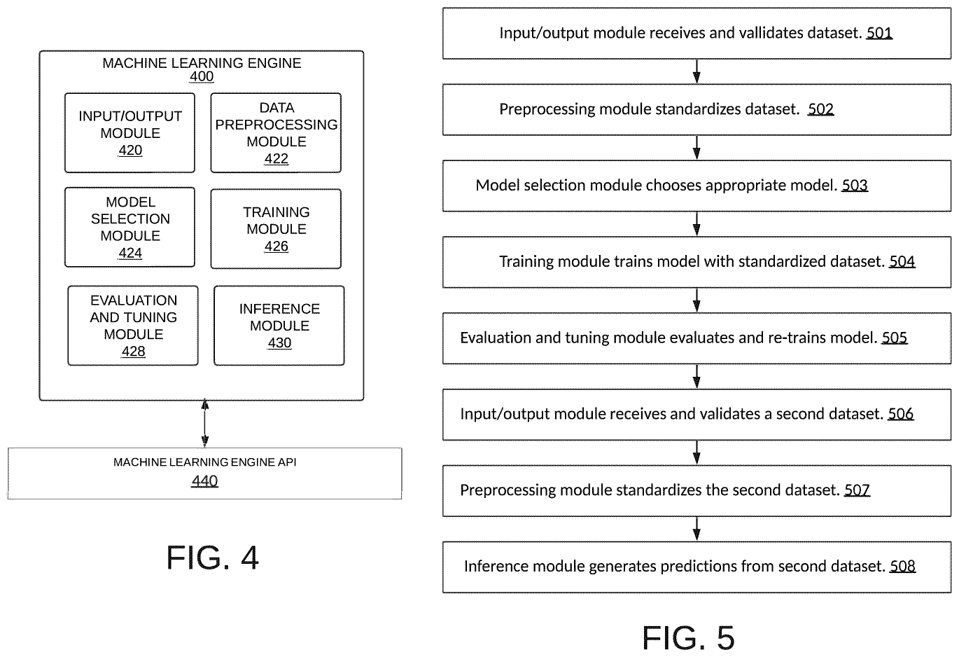

FIG. 4 illustrates a machine learning engine 400 in accordance with one or more embodiments. As illustrated in FIG. 4, machine learning engine 400 includes input/output module 420, data preprocessing module 422, model selection module 424, training module 426, evaluation and tuning module 428, and inference module 430.

In accordance with an embodiment, input/output module 420 serves as the primary interface for data entering and exiting the system, managing the flow and integrity of data. This module may accommodate a wide range of data sources and formats to facilitate integration and communication within the machine learning architecture.

In an embodiment, an input handler within input/output module 420 includes a data ingestion framework capable of interfacing with various data sources, such as databases, APIs, file systems, and real-time data streams. This framework is equipped with functionalities to handle different data formats (e.g., CSV, JSON, XML) and efficiently manage large volumes of data. It includes mechanisms for batch and real-time data processing that enable the input/output module 420 to be versatile in different operational contexts, whether processing historical datasets or streaming data.

In accordance with an embodiment, input/output module 420 manages data integrity and quality as it enters the system by incorporating initial checks and validations. These checks and validations ensure that incoming data meets predefined quality standards, like checking for missing values, ensuring consistency in data formats, and verifying data ranges and types. This proactive approach to data quality minimizes potential errors and inconsistencies in later stages of the machine learning process.

In an embodiment, an output handler within input/output module 420 includes an output framework designed to handle the distribution and exportation of outputs, predictions, or insights. Using the output framework, input/output module 420 formats these outputs into user-friendly and accessible formats, such as reports, visualizations, or data files compatible with other systems. Input/output module 420 also ensures secure and efficient transmission of these outputs to end-users or other systems in an embodiment and may employ encryption and secure data transfer protocols to maintain data confidentiality.

In accordance with an embodiment, data preprocessing module 422 transforms data into a format suitable for use by other modules in machine learning engine 400. For example, data preprocessing module 422 may transform raw data into a normalized or standardized format suitable for training machine learning models and for processing new data inputs for inference. In an embodiment, data preprocessing module 422 acts as a bridge between the raw data sources and the analytical capabilities of machine learning engine 400.

In an embodiment, data preprocessing module 422 begins by implementing a series of preprocessing steps to clean, normalize, and/or standardize the data. This involves handling a variety of anomalies, such as managing unexpected data elements, recognizing inconsistencies, or dealing with missing values. Some of these anomalies can be addressed through methods like imputation or removal of incomplete records, depending on the nature and volume of the missing data. Data preprocessing module 422 may be configured to handle anomalies in different ways depending on context. Data preprocessing module 422 also handles the normalization of numerical data in preparation for use with models sensitive to the scale of the data, like neural networks and distance-based methods. Normalization techniques, such as min-max scaling or z-score standardization, may be applied to bring numerical features to a common scale, enhancing the model's ability to learn effectively.

In an embodiment, data preprocessing module 422 includes a feature encoding framework that ensures categorical variables are transformed into a format that can be easily interpreted by machine learning methods. Techniques like one-hot encoding or label encoding may be employed to convert categorical data into numerical values, making them suitable for analysis. The module may also include feature selection mechanisms, where redundant or irrelevant features are identified and removed, thereby increasing the efficiency and performance of the model.

In accordance with an embodiment, when data preprocessing module 422 processes new data for inference, data preprocessing module 422 replicates the same preprocessing steps to ensure consistency with the training data format. This helps to avoid discrepancies between the training data format and the inference data format, thereby reducing the likelihood of inaccurate or invalid model predictions.

In an embodiment, model selection module 424 includes logic for determining the most suitable method or model architecture for a given dataset and problem. This module operates in part by analyzing the characteristics of the input data, such as its dimensionality, distribution, and the type of problem (classification, regression, clustering, etc.).

In an embodiment, model selection module 424 employs a variety of statistical and analytical techniques to understand data patterns, identify potential correlations, and assess the complexity of the task. Based on this analysis, it then matches the data characteristics with the strengths and weaknesses of various available models. This can range from simple linear models for less complex problems to sophisticated deep learning architectures for tasks requiring feature extraction and high-level pattern recognition, such as image and speech recognition.

In an embodiment, model selection module 424 utilizes techniques from the field of Automated Machine Learning (AutoML). AutoML systems automate the process of model selection by rapidly prototyping and evaluating multiple models. They use techniques like Bayesian optimization, genetic methods, or reinforcement learning to explore the model space efficiently. Model selection module 424 may use these techniques to evaluate each candidate model based on performance metrics relevant to the task. For example, accuracy, precision, recall, or F1 score may be used for classification tasks and mean squared error metrics may be used for regression tasks. Accuracy measures the proportion of correct predictions (both positive and negative). Precision measures the proportion of actual positives among the predicted positive cases. Recall (also known as sensitivity) evaluates how well the model identifies actual positives. F1 Score is a single metric that accounts for both false positives and false negatives. The mean squared error (MSE) metric may be used for regression tasks. MSE measures the average squared difference between the actual and predicted values, providing an indication of the model's accuracy. A lower MSE may indicate a model's greater accuracy in predicting values, as it represents a smaller average discrepancy between the actual and predicted values.

In accordance with an embodiment, model selection module 424 also considers computational efficiency and resource constraints. This is meant to help ensure the selected model is both accurate and practical in terms of computational and time requirements. In an embodiment, certain features of model selection module 424 are configurable such as a configured bias toward (or against) computational efficiency.

In accordance with an embodiment, training module 426 manages the ‘learning’ process of machine learning models by implementing various learning methods that enable models to identify patterns and make predictions or decisions based on input data. In an embodiment, the training process begins with the preparation of the dataset after preprocessing; this involves splitting the data into training and validation sets. The training set is used to teach the model, while the validation set is used to evaluate its performance and adjust parameters accordingly. Training module 426 handles the iterative process of feeding the training data into the model, adjusting the model's internal parameters (like weights in neural networks) through backpropagation and optimization methods, such as stochastic gradient descent or other methods providing similarly useful results.

In accordance with an embodiment, training module 426 manages overfitting, where a model learns the training data too well, including its noise and outliers, at the expense of its ability to generalize to new data. Techniques such as regularization, dropout (in neural networks), and early stopping are implemented to mitigate this. Additionally, the module employs various techniques for hyperparameter tuning; this involves adjusting model parameters that are not directly learned from the training process, such as learning rate, the number of layers in a neural network, or the number of trees in a random forest.

In an embodiment, training module 426 includes logic to handle different types of data and learning tasks. For instance, it includes different training routines for supervised learning (where the training data comes with labels) and unsupervised learning (without labeled data). In the case of deep learning models, training module 426 also manages the complexities of training neural networks that include initializing network weights, choosing activation functions, and setting up neural network layers.

In an embodiment, evaluation and tuning module 428 incorporates dynamic feedback mechanisms and facilitates continuous model evolution to help ensure the system's relevance and accuracy as the data landscape changes. Evaluation and tuning module 428 conducts a detailed evaluation of a model's performance. This process involves using statistical methods and a variety of performance metrics to analyze the model's predictions against a validation dataset. The validation dataset, distinct from the training set, is instrumental in assessing the model's predictive accuracy and its capacity to generalize beyond the training data. The module's methods meticulously dissect the model's output, uncovering biases, variances, and the overall effectiveness of the model in capturing the underlying patterns of the data.

In an embodiment, evaluation and tuning module 428 performs continuous model tuning by using hyperparameter optimization. Evaluation and tuning module 428 performs an exploration of the hyperparameter space using methods, such as grid search, random search, or more sophisticated methods like Bayesian optimization. Evaluation and tuning module 428 uses these methods to iteratively adjust and refine the model's hyperparameters-settings that govern the model's learning process but are not directly learned from the data-to enhance the model's performance. This tuning process helps to balance the model's complexity with its ability to generalize and attempts to avoid the pitfalls of underfitting or overfitting.

In an embodiment, evaluation and tuning module 428 integrates data feedback and updates the model. Evaluation and tuning module 428 actively collects feedback from the model's real-world applications, an indicator of the model's performance in practical scenarios. Such feedback can come from various sources depending on the nature of the application. For example, in a user-centric application like a recommendation system, feedback might comprise user interactions, preferences, and responses. In other contexts, such as predicting events, it might involve analyzing the model's prediction errors, misclassifications, or other performance metrics in live environments.

In an embodiment, feedback integration logic within evaluation and tuning module 428 integrates this feedback using a process of assimilating new data patterns, user interactions, and error trends into the system's knowledge base. The feedback integration logic uses this information to identify shifts in data trends or emergent patterns that were not present or inadequately represented in the original training dataset. Based on this analysis, the module triggers a retraining or updating cycle for the model. If the feedback suggests minor deviations or incremental changes in data patterns, the feedback integration logic may employ incremental learning strategies, fine-tuning the model with the new data while retaining its previously learned knowledge. In cases where the feedback indicates significant shifts or the emergence of new patterns, a more comprehensive model updating process may be initiated. This process might involve revisiting the model selection process, re-evaluating the suitability of the current model architecture, and/or potentially exploring alternative models or configurations that are more attuned to the new data.

In accordance with an embodiment, throughout this iterative process of feedback integration and model updating, evaluation and tuning module 428 employs version control mechanisms to track changes, modifications, and the evolution of the model, facilitating transparency and allowing for rollback if necessary. This continuous learning and adaptation cycle, driven by real-world data and feedback, helps to endure the model's ongoing effectiveness, relevance, and accuracy.

In an embodiment, inference module 430 transforms data raw data into actionable, precise, and contextually relevant predictions. In addition to processing and applying a trained model to new data, inference module 430 may also include post-processing logic that refines the raw outputs of the model into meaningful insights.

In an embodiment, inference module 430 includes classification logic that takes the probabilistic outputs of the model and converts them into definitive class labels. This process involves an analytical interpretation of the probability distribution for each class. For example, in binary classification, the classification logic may identify the class with a probability above a certain threshold, but classification logic may also consider the relative probability distribution between classes to create a more nuanced and accurate classification.

In an embodiment, inference module 430 transforms the outputs of a trained model into definitive classifications. Inference module 430 employs the underlying model as a tool to generate probabilistic outputs for each potential class. It then engages in an interpretative process to convert these probabilities into concrete class labels.

In an embodiment, when inference module 430 receives the probabilistic outputs from the model, it analyzes these probabilities to determine how they are distributed across some or all potential classes. If the highest probability is not significantly greater than the others, inference module 430 may determine that there is ambiguity or interpret this as a lack of confidence displayed by the model.

In an embodiment, inference module 430 uses thresholding techniques for applications where making a definitive decision based on the highest probability might not suffice due to the critical nature of the decision. In such cases, inference module 430 assesses if the highest probability surpasses a certain confidence threshold that is predetermined based on the specific requirements of the application. If the probabilities do not meet this threshold, inference module 430 may flag the result as uncertain or defer the decision to a human expert. Inference module 430 dynamically adjusts the decision thresholds based on the sensitivity and specificity requirements of the application, subject to calibration for balancing the trade-offs between false positives and false negatives.

In accordance with an embodiment, inference module 430 contextualizes the probability distribution against the backdrop of the specific application. This involves a comparative analysis, especially in instances where multiple classes have similar probability scores, to deduce the most plausible classification. In an embodiment, inference module 430 may incorporate additional decision-making rules or contextual information to guide this analysis, ensuring that the classification aligns with the practical and contextual nuances of the application.

In regression models, where the outputs are continuous values, inference module 430 may engage in a detailed scaling process in an embodiment. Outputs, often normalized or standardized during training for optimal model performance, are rescaled back to their original range. This rescaling involves recalibration of the output values using the original data's statistical parameters, such as mean and standard deviation, ensuring that the predictions are meaningful and comparable to the real-world scales they represent.

In an embodiment, inference module 430 incorporates domain-specific adjustments into its post-processing routine. This involves tailoring the model's output to align with specific industry knowledge or contextual information. For example, in financial forecasting, inference module 430 may adjust predictions based on current market trends, economic indicators, or recent significant events, ensuring that the outputs are both statistically accurate and practically relevant.

In an embodiment, inference module 430 includes logic to handle uncertainty and ambiguity in the model's predictions. In cases where inference module 430 outputs a measure of uncertainty, such as in Bayesian inference models, inference module 430 interprets these uncertainty measures by converting probabilistic distributions or confidence intervals into a format that can be easily understood and acted upon. This provides users with both a prediction and an insight into the confidence level of that prediction. In an embodiment, inference module 430 includes mechanisms for involving human oversight or integrating the instance into a feedback loop for subsequent analysis and model refinement.

In an embodiment, inference module 430 formats the final predictions for end-user consumption. Predictions are converted into visualizations, user-friendly reports, or interactive interfaces. In some systems, like recommendation engines, inference module 430 also integrates feedback mechanisms, where user responses to the predictions are used to continually refine and improve the model, creating a dynamic, self-improving system.

FIG. 5 illustrates the operation of a machine learning engine in one or more embodiments. Input/output module 420 receives a dataset intended for training (operation 501). This data can originate from diverse sources, like databases or real-time data streams, and in varied formats, such as CSV, JSON, or XML. Input/output module 420 assesses and validates the data, ensuring its integrity by checking for consistency, data ranges, and types.

In an embodiment, training data is passed to data preprocessing module 422 (operation 502). Here, the data undergoes a series of transformations to standardize and clean it, making it suitable for training machine learning models. This involves normalizing numerical data, encoding categorical variables, and handling missing values through techniques like imputation.

In an embodiment, prepared data from the data preprocessing module 422 is then fed into model selection module 424 (operation 503). This module analyzes the characteristics of the processed data, such as dimensionality and distribution, and selects the most appropriate model architecture for the given dataset and problem. It employs statistical and analytical techniques to match the data with an optimal model, ranging from simpler models for less complex tasks to more advanced architectures for intricate tasks.

In an embodiment, training module 426 trains the selected model with the prepared dataset (operation 504). It implements learning methods to adjust the model's internal parameters, optimizing them to identify patterns and relationships in the training data. Training module 426 also addresses the challenge of overfitting by implementing techniques, like regularization and early stopping, ensuring the model's generalizability.

In an embodiment, evaluation and tuning module 428 evaluates the trained model's performance using the validation dataset (operation 505). Evaluation and tuning module 428 applies various metrics to assess predictive accuracy and generalization capabilities. It then tunes the model by adjusting hyperparameters, and if needed, incorporates feedback from the model's initial deployments, retraining the model with new data patterns identified from the feedback.

In an embodiment, input/output module 420 receives a dataset intended for inference. Input/output module 420 assesses and validates the data (operation 506).

In an embodiment, data preprocessing module 422 receives the validated dataset intended for inference (operation 507). Data preprocessing module 422 ensures that the data format used in training is replicated for the new inference data, maintaining consistency and accuracy for the model's predictions.

In an embodiment, inference module 430 processes the new data set intended for inference, using the trained and tuned model (operation 508). It applies the model to this data, generating raw probabilistic outputs for predictions. Inference module 430 then executes a series of post-processing steps on these outputs, such as converting probabilities to class labels in classification tasks or rescaling values in regression tasks. It contextualizes the outputs as per the application's requirements, handling any uncertainty in predictions and formatting the final outputs for end-user consumption or integration into larger systems.

In an embodiment, machine learning engine API 440 allows for applications to leverage machine learning engine 400. In an embodiment, machine learning engine API 440 may be built on a RESTful architecture and offer stateless interactions over standard HTTP/HTTPS protocols. Machine learning engine API 440 may feature a variety of endpoints, each tailored to a specific function within machine learning engine 400. In an embodiment, endpoints such as /submitData facilitate the submission of new data for processing, while /retrieveResults is designed for fetching the outcomes of data analysis or model predictions. The MLE API may also include endpoints like /updateModel for model modifications and /trainModel to initiate training with new datasets.

In an embodiment, machine learning engine API 440 is equipped to support SOAP-based interactions. This extension involves defining a WSDL (Web Services Description Language) document that outlines the API's operations and the structure of request and response messages. In an embodiment, machine learning engine API 440 supports various data formats and communication styles. In an embodiment, machine learning engine API 440 endpoints may handle requests in JSON format or any other suitable format. For example, machine learning engine API 440 may process XML, and it may also be engineered to handle more compact and efficient data formats, such as Protocol Buffers or Avro, for use in bandwidth-limited scenarios.

In an embodiment, machine learning engine API 440 is designed to integrate WebSocket technology for applications necessitating real-time data processing and immediate feedback. This integration enables a continuous, bi-directional communication channel for a dynamic and interactive data exchange between the application and machine learning engine 400.

### 8. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

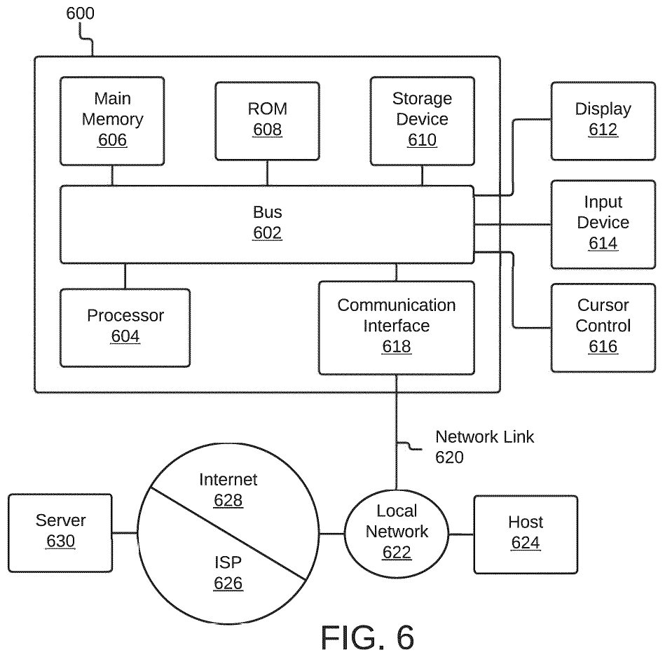

For example, FIG. 6 is a block diagram that illustrates a computer system 600 upon which an embodiment of the disclosure may be implemented. Computer system 600 includes a bus 602 or other communication mechanism for communicating information, and a hardware processor 604 coupled with bus 602 for processing information. Hardware processor 604 may be, for example, a general-purpose microprocessor.

Computer system 600 also includes a main memory 606, such as a random-access memory (RAM) or other dynamic storage device, coupled to bus 602 for storing information and instructions to be executed by processor 604. Main memory 606 also may be used for storing temporary variables or other intermediate information during execution of instructions to be executed by processor 604. Such instructions, when stored in non-transitory storage media accessible to processor 604, render computer system 600 into a special-purpose machine that is customized to perform the operations specified in the instructions.

Computer system 600 further includes a read only memory (ROM) 608 or other static storage device coupled to bus 602 for storing static information and instructions for processor 604. A storage device 610, such as a magnetic disk or optical disk, is provided and coupled to bus 602 for storing information and instructions.

Computer system 600 may be coupled via bus 602 to a display 612, such as a cathode ray tube (CRT), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane.

Computer system 600 may implement the techniques described herein using customized hard-wired logic, one or more ASICs or FPGAs, firmware, and/or program logic which in combination with the computer system causes or programs computer system 600 to be a special-purpose machine. According to one embodiment, the techniques herein are performed by computer system 600 in response to processor 604 executing one or more sequences of one or more instructions contained in main memory 606. Such instructions may be read into main memory 606 from another storage medium, such as storage device 610. Execution of the sequences of instructions contained in main memory 606 causes processor 604 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 610. Volatile media includes dynamic memory, such as main memory 606. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 602. Transmission media can also take the form of acoustic or light waves, such as those generated during radio-wave and infra-red data communications.

Various forms of media may be involved in carrying one or more sequences of one or more instructions to processor 604 for execution. For example, the instructions may initially be carried on a magnetic disk or solid-state drive of a remote computer. The remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622. For example, communication interface 618 may be an integrated services digital network (ISDN) card, cable modem, satellite modem, or a modem to provide a data communication connection to a corresponding type of telephone line. As another example, communication interface 618 may be a local area network (LAN) card to provide a data communication connection to a compatible LAN. Wireless links may also be implemented. In any such implementation, communication interface 618 sends and receives electrical, electromagnetic, or optical signals that carry digital data streams representing various types of information.

Network link 620 typically provides data communication through one or more networks to other data devices. For example, network link 620 may provide a connection through local network 622 to a host computer 624 or to data equipment operated by an Internet Service Provider (ISP) 626. ISP 626 in turn provides data communication services through the worldwide packet data communication network now commonly referred to as the “Internet” 628. Local network 622 and Internet 628 both use electrical, electromagnetic, or optical signals that carry digital data streams. The signals through the various networks and the signals on network link 620 and through communication interface 618, which carry the digital data to and from computer system 600, are example forms of transmission media.

Computer system 600 can send messages and receive data, including program code, through the network(s), network link 620 and communication interface 618. In the Internet example, a server 630 might transmit a requested code for an application program through Internet 628, ISP 626, local network 622 and communication interface 618.

The received code may be executed by processor 604 as it is received, and/or stored in storage device 610, or other non-volatile storage for later execution.

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

What is claimed is:

1. A method comprising:
obtaining a set of training data for training a machine learning model to generate interface element attributes for interface elements within a data collection interface;
wherein the set of training data comprises a training dataset including:
a first form field characteristic associated with a first field in a first form;
a first interface element attribute associated with a first interface element corresponding to the first field in the first form;
receiving form metadata for a target form;
applying the machine learning model to the form metadata to generate a target set of interface element attributes corresponding to a target set of interface elements; and
generating a data collection interface comprising the target set of interface elements, with the target set of interface element attributes, for collecting user input corresponding to the target form, wherein the method is performed by at least one device including a hardware processor.

2. The method of claim 1, wherein the target set of interface element attributes defines an instruction for soliciting user input via the data collection interface for a particular field in the target form, wherein the instruction is determined by the machine learning model based at least in part on a field name defined by the form metadata for the target form.

3. The method of claim 1, wherein at least one of the target set of interface element attributes define a character limit for a displayed text input box, presented by the data collection interface, for collecting user input for a particular field in the target form, and wherein the machine learning model determines the character limit for the displayed text input box based on an amount of space within the target form corresponding to an input region for the particular field, the amount of space being defined in the form metadata.

4. The method of claim 1, further comprising:
after applying the machine learning model to form metadata, storing the target form and the target set of interface elements as additional training data;
periodically retraining the machine learning model using the additional training data to improve accuracy in generating interface element attributes for subsequent form updates; and
applying the retrained machine learning model to subsequent form metadata to generate improved interface element attributes for data collection interfaces.

5. The method of claim 1, wherein the machine learning model is trained to generate interface element attributes by:
analyzing correlations between original field names in historical forms and corresponding displayed field names in previously produced data collection interfaces;
analyzing correlations between original instructions in the historical forms and corresponding displayed instructions in the previously produced data collection interfaces; and
analyzing additional correlations between space allocations in the historical forms and corresponding character limits in the previously produced data collection interfaces.

6. The method of claim 1, wherein generating the data collection interface includes translating an original instruction within the target form to a displayed instruction presented by the data collection interface, wherein the translation comprises at least one of shortening or adding more detail to an instruction based on patterns learned by the machine learning model.

7. The method of claim 1, further comprising extracting the form metadata from the target form, wherein the form metadata includes at least one of field names, instructions, space allocations for input fields, field types, and form structure information.

8. The method of claim 1, wherein the machine learning model is configured to translate an original field name from the target form to a displayed field name presented by the data collection interface, wherein the translation is based on patterns learned from correlations between original field names in historical forms and corresponding displayed field names in previously produced data collection interfaces.

9. The method of claim 1, wherein the interface element attributes generated by the machine learning model include display characteristics specific to different types of form fields, wherein the different types of form fields comprise at least two of: text input fields, numeric input fields, selection fields, date fields, and signature fields.

10. One or more non-transitory computer readable media comprising instructions which, when executed by one or more hardware processors, cause performance of operations comprising:
obtaining a set of training data for training a machine learning model to generate interface element attributes for interface elements within a data collection interface;
wherein the set of training data comprises a training dataset including:
a first form field characteristic associated with a first field in a first form;
a first interface element attribute associated with a first interface element corresponding to the first field in the first form;
receiving form metadata for a target form;
applying the machine learning model to the form metadata to generate a target set of interface element attributes corresponding to a target set of interface elements; and
generating a data collection interface comprising the target set of interface elements, with the target set of interface element attributes, for collecting user input corresponding to the target form.

11. The non-transitory computer readable media of claim 10, wherein the target set of interface element attributes defines an instruction for soliciting user input via the data collection interface for a particular field in the target form, wherein the instruction is determined by the machine learning model based at least in part on a field name defined by the form metadata for the target form.

12. The non-transitory computer readable media of claim 10, wherein at least one of the target set of interface element attributes define a character limit for a displayed text input box, presented by the data collection interface, for collecting user input for a particular field in the target form, and wherein the machine learning model determines the character limit for the displayed text input box based on an amount of space within the target form corresponding to an input region for the particular field, the amount of space being defined in the form metadata.

13. The non-transitory computer readable media of claim 10, further comprising:
after applying the machine learning model to form metadata, storing the target form and the target set of interface elements as additional training data;
periodically retraining the machine learning model using the additional training data to improve accuracy in generating interface element attributes for subsequent form updates; and
applying the retrained machine learning model to subsequent form metadata to generate improved interface element attributes for data collection interfaces.

14. The non-transitory computer readable media of claim 1, wherein the machine learning model is trained to generate interface element attributes by:
analyzing correlations between original field names in historical forms and corresponding displayed field names in previously produced data collection interfaces;
analyzing correlations between original instructions in the historical forms and corresponding displayed instructions in the previously produced data collection interfaces; and
analyzing additional correlations between space allocations in the historical forms and corresponding character limits in the previously produced data collection interfaces.

15. The non-transitory computer readable media of claim 10, wherein generating the data collection interface includes translating an original instruction within the target form to a displayed instruction presented by the data collection interface, wherein the translation comprises at least one of shortening or adding more detail to an instruction based on patterns learned by the machine learning model.

16. A system comprising:
at least one device including a hardware processor;
the system being configured to perform operations comprising:
obtaining a set of training data for training a machine learning model to generate interface element attributes for interface elements within a data collection interface;
wherein the set of training data comprises a training dataset including:
a first form field characteristic associated with a first field in a first form;
a first interface element attribute associated with a first interface element corresponding to the first field in the first form;
receiving form metadata for a target form;
applying the machine learning model to the form metadata to generate a target set of interface element attributes corresponding to a target set of interface elements; and
generating a data collection interface comprising the target set of interface elements, with the target set of interface element attributes, for collecting user input corresponding to the target form.

17. The system of claim 16, wherein the target set of interface element attributes defines an instruction for soliciting user input via the data collection interface for a particular field in the target form, wherein the instruction is determined by the machine learning model based at least in part on a field name defined by the form metadata for the target form.

18. The system of claim 16, wherein at least one of the target set of interface element attributes define a character limit for a displayed text input box, presented by the data collection interface, for collecting user input for a particular field in the target form, and wherein the machine learning model determines the character limit for the displayed text input box based on an amount of space within the target form corresponding to an input region for the particular field, the amount of space being defined in the form metadata.

19. The system of claim 16, further being configured to:
after applying the machine learning model to form metadata, storing the target form and the target set of interface elements as additional training data;
periodically retraining the machine learning model using the additional training data to improve accuracy in generating interface element attributes for subsequent form updates; and
applying the retrained machine learning model to subsequent form metadata to generate improved interface element attributes for data collection interfaces.

20. The system of claim 16, wherein the machine learning model is trained to generate interface element attributes by:
analyzing correlations between original field names in historical forms and corresponding displayed field names in previously produced data collection interfaces;
analyzing correlations between original instructions in the historical forms and corresponding displayed instructions in the previously produced data collection interfaces; and
analyzing additional correlations between space allocations in the historical forms and corresponding character limits in the previously produced data collection interfaces.
